(19) United States
(12) Patent Application Publication
(10) Pub. No.: US 2006/0008625 A1
(43) Pub. Date: Jan. 12, 2006

(54) Vehicle window unit with foam based seal and corresponding method

(75) Inventors: Duane Recker, Auburn, IN (US); Keith Aldrich, Waterloo, IN (US); Rick Lopez, Shelby Township, MI (US); Jerry Wolf, Clarkston, MI (US)

Correspondence Address: NIXON & VANDERHYE, PC, 901 NORTH GLEBE ROAD, 11TH FLOOR, ARLINGTON, VA, 22203, US

(73) Assignee: Guardian Industries Corp., Auburn Hills, MI (US)

(21) Appl. No.: 10/888,542

(22) Filed: Jul. 12, 2004

(51) Int. Cl. B29C 44/00; B29C 67/00

(52) U.S. Cl. 428/195.1; 264/46.4; 264/252; 156/60

(57) ABSTRACT

In certain example embodiments of this invention, a foam type spacer/seal is used proximate the edge of a vehicle window. The use of foam in such applications is advantageous in that it permits high-profile shaped spacers/seals to be efficiently formed in a manner which does not sacrifice yields. In certain example embodiments, polyurethane-based foam may be used.

This invention relates to a vehicle window unit including a foam based edge seal proximate an edge portion thereof, and corresponding method. In certain example embodiments of this invention, the use of a foam-type edge seal or spacer proximate a periphery of a window is advantageous in that it permits high-profile (i.e., profiles having a height greater than width) seals/spacers to be made in an efficient manner. The edge seal or spacer may be used in conjunction with a vehicle windshield, backlite, sidelite or any other type of vehicle glazing.

### BACKGROUND OF THE INVENTION

It is known to provide a glass substrate with a frame-like polymer profile, or edge seal, proximate an edge portion thereof. Such profiles may act as a weather seal between the glazing and an adjacent vehicle window frame. In other instances, such profiles may be used as an intermediate body (or spacer) to which an adhesive bead is applied during the assembly of automotive windows, where the bead bonds the profile to a corresponding window frame of the vehicle. Such profiles sometimes include a lip that may be used either for centering purposes (e.g., see U.S. Pat. No. 5,384,995, incorporated herein by reference), or alternatively as a weatherstrip (e.g., water seal) and/or gap covering unit.

Edge seals have typically been formed on glass substrates via either reaction injection molding, or extrusion. Reaction injection molding (RIM) is disadvantageous in that, for example, very high temperatures are often required at the glass and expensive equipment is needed. Moreover, RIM tends to have relatively high density characteristics which can be disadvantageous for reasons discussed below (e.g., sound barrier reasons).

In certain example non-limiting instances, a need has arisen for a window seal/spacer having a high-profile shape. A “high-profile” shape means that the seal or spacer has a height which is greater than its width at most or all locations of the seal or spacer. Unfortunately, conventional extrusion techniques are not well suited for forming high-profile seals/spacers. In particular, using conventional extrusion techniques, if a high-profile shape is originally extruded it sometimes tends to sag, bend, or otherwise deform into an undesirable shape.

Thus, it will be appreciated that there exists a need in the art for a high-profile spacer/seal for use in vehicle window applications, and/or a method of making the same in a manner which permits high-profile seals/spacers to be efficient made.

In other example instances, there exists a need in the art for a spacer/seal for use in vehicle window applications which can improve sound barrier characteristics.

### BRIEF SUMMARY OF EXAMPLE EMBODIMENTS OF THE INVENTION

In certain example embodiments of this invention, a foam type spacer/seal is used proximate the edge of a vehicle window. The use of foam in such applications is advantageous in that it permits high-profile shaped spacers/seals to be efficiently formed in a manner which does not sacrifice yields. Another example advantage of the use of foam in such applications is that it improve noise barrier characteristics in certain instances.

In certain example embodiments of this invention, foam is originally extruded onto a major surface of a glass substrate proximate an edge portion thereof, at a peripheral portion of the substrate. When originally extruded onto the substrate (which may be primed), the foam has a first height. Then, during curing of the foam, gas is given off during foaming such that the foam swells so as to ultimately realize a second height greater than the first height. Thus, the first or smaller height is present when the foam is most pliable (i.e., immediately after it has been extruded and before it has cured) thereby rendering the foam when in its vulnerable stage less top-heavy and thus less likely to sag, bend or fall. As the foam becomes stronger during the curing process, it also swells or grows to its ultimate height (the second height). Thus, by the time the foam reaches its second higher height, the foam has at least partially cured and is stronger and thus better able to withstand the top-heavy nature of a high-profile shape. Advantageously, this permits high-profile spacer or seal shapes to be made in an efficient manner.

In certain example embodiments of this invention, the growth of the foam in the vertical direction during curing is maximized by flipping over the glass substrate after the foam has been originally extruded thereon. This allows gravity to help the foam reach a greater height which is often desirable in high profile applications.

A polyurethane (PU) foam may be used in certain example embodiments of this invention.

In certain example embodiments of this invention, there is provided a method of making at least part of a vehicle window unit including a high-profile type polymer inclusive frame profile supported by a glass substrate, the method comprising: providing a glass substrate; mixing a first component comprising polyol and a second component comprising isocyanate together to form a foam mixture; extruding the foam mixture onto a peripheral portion of a major surface of the glass substrate, wherein the foam mixture has a first height dimension (H1) immediately after being extruded; the extruded foam mixture on the glass substrate emitting gas and enlarging so as to form a polymer inclusive foam frame profile on the glass substrate having a second height dimension (H2), where H2>H1, and wherein the polymer inclusive foam frame profile has a height dimension (H2) which is greater than its width dimension (W).

In certain other example embodiments of this invention, there is provided a method of making at least part of a vehicle window unit including a polymer inclusive spacer supported by a glass substrate, the method comprising: providing a glass substrate; mixing a first component comprising polyol and a second component comprising isocyanate together to form a foam mixture; extruding the foam mixture onto a peripheral portion of a major surface of the glass substrate, wherein the foam mixture has a first height dimension (H1) immediately after being extruded; the extruded foam mixture on the glass substrate emitting gas and enlarging so as to form a polymer inclusive foam spacer on the glass substrate having a second height dimension (H2), where H2>H1.

In certain other example embodiments of this invention, there is provided a glazing part for use in a vehicle window unit, comprising: a high-profile type polymer inclusive spacer supported by a glass substrate, wherein the spacer comprises polyurethane foam including a first component comprising polyol and a second component comprising isocyanate; and wherein the foam spacer has a height dimension which is greater than its width dimension.

### BRIEF DESCRIPTION OF THE DRAWINGS

FIG. 1 is side cross sectional view of a portion of a vehicle window unit according to an example embodiment of this invention.

FIG. 2 is a schematic diagram illustrating how a foam spacer or edge seal is formed on glass substrate according to an example embodiment of this invention.

FIG. 3 is a flowchart illustrating certain steps carried out in making a vehicle window unit according to an example embodiment of this invention.

### DETAILED DESCRIPTION OF EXAMPLES OF THE INVENTION

Referring now to the accompanying drawings in which like reference numerals indicate like parts throughout the several views.

In certain example embodiments of this invention, a foam type spacer/seal is used proximate the edge of a vehicle window. The use of foam in such applications is advantageous in that it permits high-profile shaped spacers/seals to be efficiently formed in a manner which does not sacrifice yields.

In certain example embodiments of this invention, a glass substrate is primed at least at a peripheral portion thereof. After the primer has dried, foam is originally extruded onto a major surface of a glass substrate proximate an edge thereof, at a peripheral portion of the substrate. The foam may be extruded around the entire periphery of the glass substrate (e.g., around all four sides), or alternatively around one, two or three sides in different embodiments of this invention. When originally extruded onto the substrate (over the primer), the foam has a first height (H1). Then, during curing of the foam, gas (e.g., carbon dioxide) is given off during foaming such that the foam swells so as to ultimately realize a second height (H2) greater than the first height. Thus, the first or smaller height (H1) is present when the foam is most pliable (i.e., immediately after it has been extruded and before it has cured) thereby rendering the foam when in its most vulnerable stage less top-heavy and thus less likely to sag, bend or fall. As the foam becomes stronger during the curing process, it swells or grows to its ultimate height (the second height). By the time the foam reaches its second higher height (H2), the foam has at least partially cured and is stronger and thus better able to withstand the top-heavy nature of a high-profile shape. Advantageously, this permits high-profile spacer or seal shapes to be made in an efficient manner, and the ultimate high profile shape of the edge seal or spacer is only reached once the foam has at least partially cured and is thus able to better withstand the top-heavy nature of its shape without suffering damage. In certain example embodiments of this invention, H2/H1 is at least about 1.1, more preferably at least about 1.25, and even more preferably at least about 1.4.

Examples reasons why the use of foam according to certain example embodiments of this invention is better than RIM, are as follows. The main difference here is that RIM polyurethane has a specify gravity or density right around 1.0 and the foam has a density of less than about 0.50, more preferably less than about 0.40, even more preferably less than about 0.30, e.g., about 0.20. The density difference is caused by the extremely large number of air cells created inside the foam (e.g., PU foam). These air cells act like dampeners, and do not easily allow the transmission of sound waves to be transmitted through it. Additionally, the foam acts like a sound deadener when placed around the perimeter of a piece of glass and does not allow the glass to reverberate (or reduces same) which also lowers the noise level allowed to be transmitted through it. As will be appreciated by those of skill in the art, there is no specific unit when giving density measurements this way. The standard density of 1.0 was developed based on water, which is most dense at 34 degrees F. Thus, for example, a given volume of steel, which has a density of 6.2, means that that volume of steel weighs 6.2 times more than the same volume of water does at its most dense state. Foams, on the other hand, generally weigh less than a given volume of water, which is why there densities are given as fractions of one.

While PU is a preferred foam material herein, it is possible that other foams may also or instead be used.

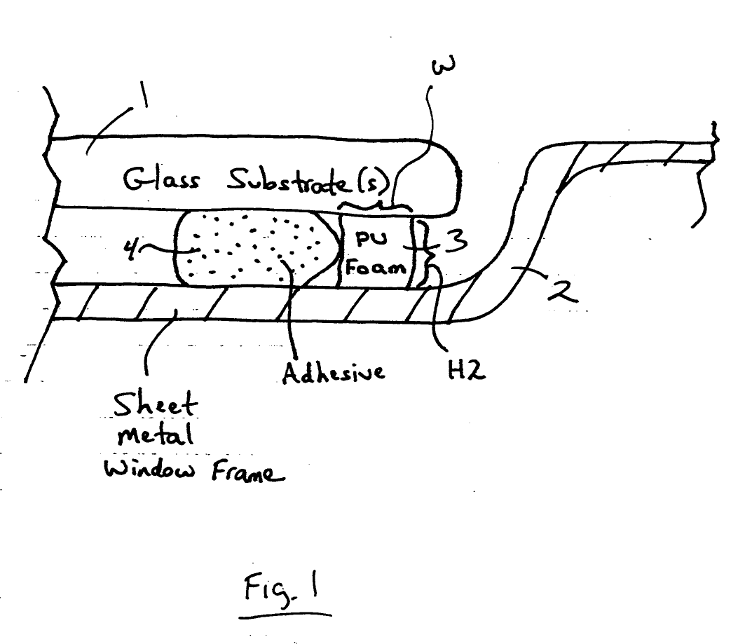

FIG. 1 is a cross sectional view of part of a window unit according to an example embodiment of this invention. The window unit includes glass substrate 1 and window frame 2 which is typically of sheet metal or the like. The window frame 2 includes an opening (not shown) in an area thereof where the viewing part of the window is defined. Polyurethane (PU) based foam polymer based profile frame (e.g., spacer and/or edge seal) 3 is formed on the glass substrate 1 (preferably over an optional primer(s)—not shown). After the PU foam spacer or edge seal 3 has been formed on the glass substrate 1 and has cured, an adhesive 4 is extruded onto the glass substrate and then the glass substrate 1 with the cured foam spacer/seal 3 and adhesive 4 thereon is inserted into the opening of the window frame 2. When the glass substrate 1 is inserted into the opening in the window frame, the adhesive 4 functions to bond the glass substrate to the window frame 2, while the spacer/seal functions: (a) to space the glass 1 the proper distance from the window frame 2 thereby maintaining the proper adhesive thickness/height; (b) to prevent the adhesive from squeezing out through the gap between the frame 2 and the edge of the glass substrate; (c) as a noise barrier to help reduce noise from outside the vehicle from making its way into the vehicle interior.

Referring to FIGS. 1-3, an example process for making a window unit according to an example embodiment of this invention will now be described.

Generally, a PU foam process is used to extrude onto a glass surface a polyurethane mixture, that upon reacting, produces uniform appearing foam with consistent dimensions and specific density.

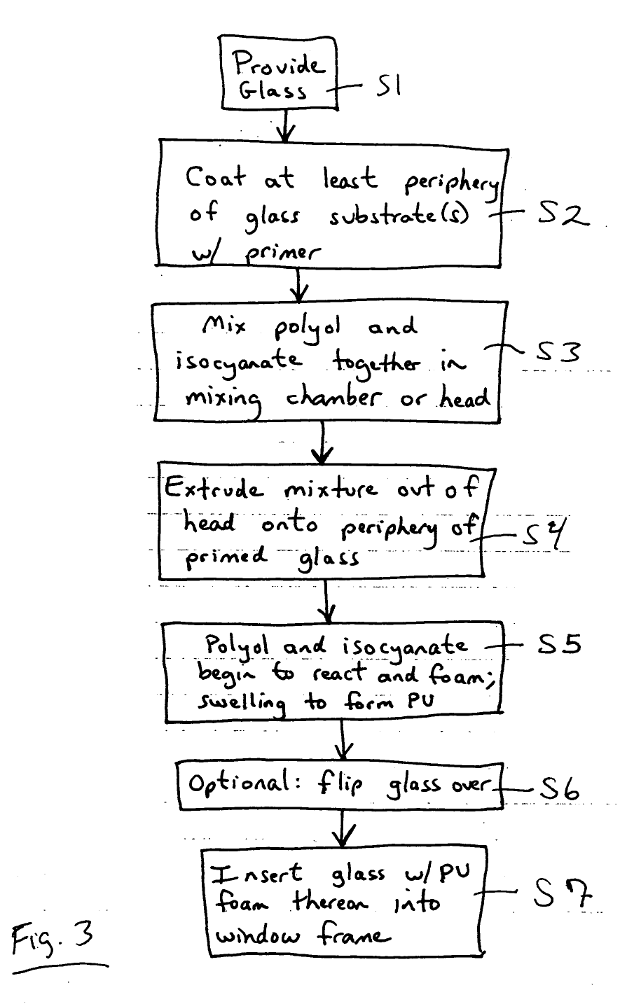

Initially, a glass substrate 1 is provided (S1 in FIG. 3). The glass substrate 1 may or may not be laminated to another glass substrate in different embodiments of this invention. A major surface of the glass substrate 1 is primed with one or more glass primers, typically only proximate an edge thereof (i.e., along a peripheral portion where the seal or spacer, and/or adhesive, is to be formed) (S2 in FIG. 3). Example primers are Dow's 435-18 glass primer followed by Dow's 435-20A black primer, in a two primer embodiment. After being primed, the primer is allowed to dry and then the foam can be applied directly to the primed surface.

Other glass primers may also or instead be used. For example, other glass primers that may be used are commercially available from Eftec, YH America, and Lord Chemical Corporation.

An example PU foam which may be used for spacer and/or edge seal 3 is Product 9299 available from H.B. Fuller Corporation. In certain example instances, a low pressure urethane foaming machine from Nordson Corporation may be used to apply the foam to the glass substrate 1 over the primed surface thereof.

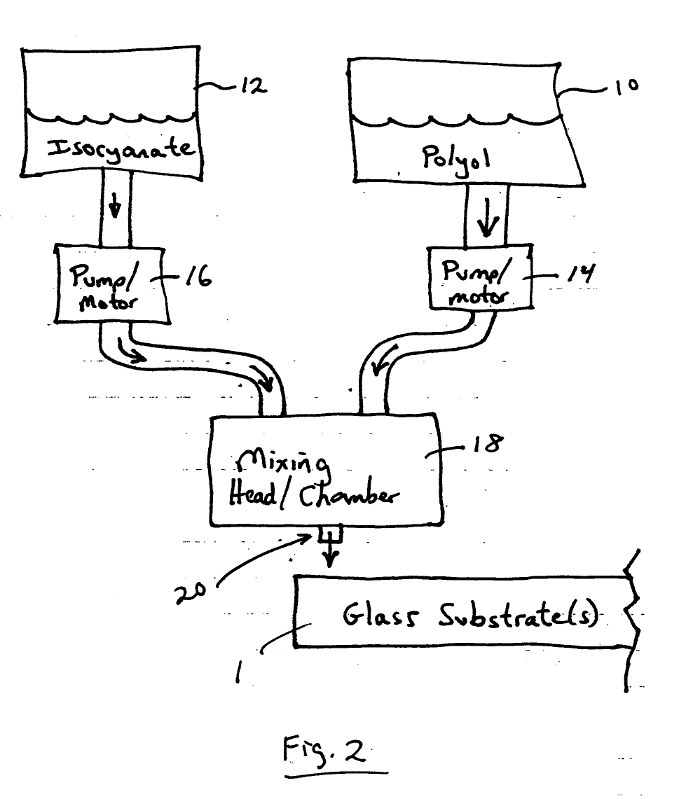

As shown in FIG. 2, an example low pressure urethane foam deposition system includes two material storage tanks (10 and 12), one tank 10 being for a polyol component and the other tank 12 being for an isocyanate component. These two components are the two components that when mixed, create the polyurethane, although other materials may also be used. The materials from each tanks 10, 12 is piped to a respective pump (14, 16) which will pump the individual component to a mixing head, or mixing chamber 18. The pumps 14, 16 are individually controlled through the use of respective variable speed drive motors. A given motor is provided for each pump 14, 16. This allows the machine user to vary the ratio of the two components (e.g., polyol and isocyanate) by changing the motor speeds.

In the mixing chamber 18, the two chemical components (e.g., polyol and isocyanate) are introduced to one another and are dynamically mixed by a high speed mixer (S3 in FIG. 3). The newly mixed material is then allowed to flow out of the mixing chamber through an orifice opening 20 onto the area of the glass substrate 1 where the spacer/seal 3 is to be formed (S4 in FIG. 3). In certain example embodiments of this invention, orifice opening 20 is approximately circular and has a diameter of from about 2 to 4 mm, more preferably about 3 mm. The mixing chamber 18, as well as the orifice opening 20, may be attached to the end of a 6 axis robot in certain example embodiments of this invention. The role of the robot is to traverse around the perimeter of the glass 1 while simultaneously controlling the extruding of the mixed material onto the glass surface at the periphery thereof. Given the use of the polyol and isocyanate in appropriate mixed ratio(s), sufficient machine controls exist to control the proper lay down rate of the foam to achieve the uniformity of appearance and size of the spacer/seal 3. In addition to the polyol and isocyanate, it is possible for other materials (e.g., fillers, etc.) to be used in the polyurethane spacer/seal 3 in certain example embodiments of this invention.

After being applied on the glass substrate 1 (or possibly as it is being applied to the glass substrate 1), the newly mixed materials (e.g., polyol and isocyanate) begin to react, starting the process of creating polyurethane (S5 in FIG. 3). After partially reacting, various gases, primarily C02, are being produced by the foam due to the chemical reaction and cause the PU to foam up and swell in size (S5 in FIG. 3). This foaming action is a fundamental result of the chemical reaction of the polyol and the isocyanate when foaming material are used, but the foaming action can also be influenced by other factors. These factors include nucleation, or adding air into the polyol component prior to mixing and by heating up the glass article prior to having the mixed material applied to the glass. Both of these factors affect the size and uniformity of the gas bubbles being formed inside the foam, which in turn affect the final foam size, form and density. In certain example embodiments of this invention, the glass substrate may be heated to a temperature of at least 100 degrees F. during foam application from the extruding head 18, more preferably at least 150 degrees F., and most preferably at least 200 degrees F.

Another factor that has surprisingly been found to affect the geometry of the final foam spacer/seal 3 shape, is the orientation of the glass substrate 1 soon after original extrusion of the foam onto the same. In certain example embodiments, after applying the newly mixed material to the glass surface via the extrusion head 18, the glass substrate 1 with the extruded foam thereon can be immediately flipped over so that the foam projects vertically downward from the surface of the glass substrate (S6 in FIG. 3). In certain example embodiments of this invention, the glass substrate 1 is flipped over within about 1 minutes after the foam has been extruded onto the same (i.e., within about 1 minutes after all of the foam has been extruded onto the substrate), more preferably within about 30 seconds, even more preferably within about 15 seconds, and most preferably within about 10 seconds.

This flipping action of the glass substrate with foam thereon has been found to enhance the foam dimension in the height direction, and allows achievement of a higher height to width ratio of the spacer/seal 3 in final foam form. Probably, this is due to the force of gravity acting on the foam during curing. After flipping the part over, the glass typically remains in that position for at least about 5 minutes, more preferably at least about 7 minutes and most preferably at leas about 10 minutes. This is typically the length of time required for the polyurethane to fully react and form in final shape. After this time, the newly made part with foam spacer/seal 3 can be safely handled without detriment to the final part.

After the foam has cured and formed spacer/seal 3 bonded to the glass substrate over primer, the glass substrate 1 with the spacer/seal 3 thereon is attached to a vehicle window frame 2 as discussed above in certain example embodiments of this invention (S7 in FIG. 3).

The final foam 3 dimensions can be controlled to an acceptable level by controlling one or more of a number of process variables. These variables include:
(a) Varying the ratio of the polyol and isocyanate components. Depending upon PU foam systems being used, the ratio on components may be from about 3 to 1 up to about a 7 to 1 ratio, with the higher number representing the amount of polyol component.
(b) Varying the extrusion rate. Higher application rates lead to a higher, wider foam.
(c) Varying the robot speed. Speeding up the robot leads to a smaller foam while slowing the robot down leads to a thicker, taller foam.
(d) Heating the glass affects the foam dimensions. Heating the glass leads to a taller, less wide foam.
(e) Flipping the glass allows the foam to become taller, without compromising the width dimension of the final foam.
   By controlling one or more of these variables, it is possible to achieve the design requirements for the various products.

In certain example embodiments of this invention, the aforesaid foaming techniques are particularly applicable to high profile spacers and/or edge seals having a height dimension (H2) greater than its width dimension (W) (see FIG. 12). In certain example embodiments, then H2>W (i.e., high profile shape). In certain embodiments, the height to width ratio (H2/W) is at least about 1.1, more preferably at least about 1.2, and often at least about 1.3. In an example windshield application, the PU foam spacer/seal 3 had a width of about 6 mm and a height of about 8.5 mm. By changing certain variables, one can create other ratios. For instance, for a given backlite application, the PU foam spacer/seal 3 had a width of about 5 mm and a height of about 7 mm.

While certain example embodiments discussed above realize a ratio H2/W of at least 1.0, this invention is not so limited unless feature is claimed. For example, in alternative embodiments, some potential foam applications may be characterized by a ratio H2/W of 1.0 or less, e.g., from about 0.75 to 1.0.

In certain example embodiments of this invention, it may be possible to achieve a higher height to width ratio (H2/W) by having a part processed twice through the foaming process. That is, run a part through the foaming area a first time allowing the foam to rise and partially or entirely cure, then process the part again, extruding the foam a second time over and on the first foam, then allowing the second foam portion to rise and cure. This would permit even higher height to width ratios to be achieved.

In certain example embodiments of this invention, example advantages are set forth below. Certain embodiments of this invention are particularly adapted for use in applications involving automotive windshields, backlites, and quarter glass. Example advantages include:
(a) Ideal sealing method for any windshield or other glass with a designed bare-edge glass look.
(b) PU foam 3 closes out the back surface gap between the glass 1 and the vehicle body.
(c) PU foam 3 prevents or reduces inadvertent squeezing out of the adhesive 4 (e.g., urethane adhesive 4) used to bond glass 1 to vehicle window frames 2.
(d) PU foam 3, with proper foam dimensions and density, serves as a uniform thickness spacer to properly set adhesive 4 thickness to proper installation thickness.
(e) PU foam readily lowers outside wind noise potential as the gap between the glass 1 and the vehicle opening becomes more uniform and more consistent.
(f) PU foam acts as a sound deadener, which also greatly lowers wind noise and sound transmission into the vehicle compartment. PU foam eliminates the need for any additional exterior reveal moldings normally applied to glass/vehicle openings in certain example instances.
(g) The inside surface of the foam 3 engages the sheet metal window frame 2 of the vehicle and the foam compresses 3 to the final design shape. The foam 3 then acts as a wind, air, and noise sealant greatly decreasing sound inside the vehicle.

While example embodiments of the invention have been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method of making at least part of a vehicle window unit including a high-profile type polymer inclusive frame profile supported by a glass substrate, the method comprising:
providing a glass substrate;
mixing a first component comprising polyol and a second component comprising isocyanate together to form a foam mixture;
extruding the foam mixture onto a peripheral portion of a major surface of the glass substrate, wherein the foam mixture has a first height dimension (H1) immediately after being extruded;
the extruded foam mixture on the glass substrate emitting gas and enlarging so as to form a polymer inclusive foam frame profile on the glass substrate having a second height dimension (H2), where H2>H1, and wherein the polymer inclusive foam frame profile has a height dimension (H2) which is greater than its width dimension (W).

2. The method of claim 1, wherein the foam frame profile is provided along all four sides of the glass substrate.

3. The method of claim 1, wherein the foam frame profile is provided along at least one side of the glass substrate, and wherein the foam frame profile has a density of less than about 0.50.

4. The method of claim 1, wherein the foam comprises polyurethane.

5. The method of claim 1, wherein the mixture is extruded onto a top surface of the glass substrate, and wherein the method further comprises flipping the glass substrate over shortly after the mixture has been extruded onto the glass substrate and before the mixture has cured, so that after the glass substrate has been flipped over the foam is on the side of the glass substrate closest to the ground.

6. The method of claim 1, wherein H2/W is at least about 1.1.

7. The method of claim 1, wherein H2/W is at least about 1.2.

8. The method of claim 1, wherein H2/W is at least about 1.3.

9. The method of claim 1, wherein H2/H1 is at least about 1.1.

10. The method of claim 1, wherein H2/H1 is at least about 1.25.

11. The method of claim 1, wherein H2/H1 is at least about 1.4.

12. The method of claim 1, wherein an opaque primer film is formed on the glass substrate so as to be located between the glass substrate and the polymer inclusive foam frame profile.

13. The method of claim 1, wherein the glass substrate with the polymer inclusive foam frame profile thereon is attached to a window frame of a vehicle after the foam frame profile has cured, the glass substrate being adhered to the window frame with an adhesive, and wherein the polymer inclusive foam frame profile is positioned so as to contact the window frame of the vehicle so as to prevent the adhesive from squeezing out of a gap between the window frame and an edge of the glass substrate.

14. A method of making a glazing part for use in a vehicle window unit, the glazing part including a polymer inclusive frame profile supported by a glass substrate, the method comprising:
providing a glass substrate;
mixing at least first and second components together to form a foam mixture;
extruding the foam mixture onto at least a peripheral portion of a major surface of the glass substrate, wherein the foam mixture has a first height dimension (H1) immediately after being extruded;
prior to curing, the extruded foam mixture on the glass substrate emitting gas and enlarging so as to form a polymer inclusive foam frame profile on the glass substrate having a second height dimension (H2), where H2>H1, and wherein the polymer inclusive foam frame profile has a height dimension (H2) which is greater than its width dimension (W).

15. The method of claim 14, wherein the foam frame profile is provided along all four sides of the glass substrate.

16. The method of claim 14, wherein the foam frame profile is provided along at least one side of the glass substrate.

17. The method of claim 14, wherein the foam comprises polyurethane, and wherein the first component consists essentially of polyol and the second component consists essentially of isocyanate.

18. The method of claim 14, wherein the mixture is extruded onto a top surface of the glass substrate, and wherein the method further comprises flipping the glass substrate over shortly after the mixture has been extruded onto the glass substrate and before the mixture has cured, so that after the glass substrate has been flipped over the foam is on the side of the glass substrate closest to the ground.

19. The method of claim 14, wherein H2/W is at least about 1.1.

20. The method of claim 14, wherein H2/W is at least about 1.2.

21. The method of claim 14, wherein H2/H1 is at least about 1.1.

22. The method of claim 14, wherein H2/H1 is at least about 1.25.

23. The method of claim 14, wherein an opaque primer film is formed on the glass substrate so as to be located between the glass substrate and the polymer inclusive foam frame profile.

24. The method of claim 14, wherein the glass substrate with the polymer inclusive foam frame profile thereon is attached to a window frame of a vehicle after the foam frame profile has cured, the glass substrate being adhered to the window frame with an adhesive, and wherein the polymer inclusive foam frame profile is positioned so as to contact the window frame of the vehicle so as to prevent the adhesive from squeezing out of a gap between the window frame and an edge of the glass substrate.

25. A method of making at least part of a vehicle window unit including a polymer inclusive spacer supported by a glass substrate, the method comprising:
providing a glass substrate;
mixing a first component comprising polyol and a second component comprising isocyanate together to form a foam mixture;
extruding the foam mixture onto a peripheral portion of a major surface of the glass substrate, wherein the foam mixture has a first height dimension (H1) immediately after being extruded;
the extruded foam mixture on the glass substrate emitting gas and enlarging so as to form a polymer inclusive foam spacer on the glass substrate having a second height dimension (H2), where H2>H1.

26. A glazing part for use in a vehicle window unit, comprising:
a polymer inclusive spacer supported by a glass substrate, wherein the spacer comprises polyurethane foam including a first component comprising polyol and a second component comprising isocyanate.

27. The glazing part of claim 26, wherein the foam spacer is provided along all four sides of the glass substrate.

28. The glazing part of claim 26, wherein the foam spacer is provided along at least one side of the glass substrate, and wherein the foam spacer has a height dimension which is greater than its width dimension.

29. The glazing part of claim 26, wherein the foam spacer has a height dimension H and a width dimension W, and wherein H/W is at least about 1.1.

30. The glazing part of claim 29, wherein H/W is at least about 1.2.

31. The glazing part of claim 29, wherein H/W is at least about 1.3.

32. The glazing part of claim 26, wherein an opaque primer film including at least one layer is formed on the glass substrate so as to be located between the glass substrate and the foam spacer.

33. The glazing part of claim 26, wherein the foam spacer has a density of less than about 0.50.

34. The glazing part of claim 26, wherein the foam spacer has a density of less than about 0.40.

35. The glazing part of claim 26, wherein the foam spacer has a density of less than about 0.30.

36. The method of claim 1, wherein the foam has a density of less than about 0.40.

37. The method of claim 14, wherein the foam frame profile has a density of less than about 0.40.

38. A vehicle window unit comprising the glazing part of claim 26.

39. A method of making at least part of a vehicle window unit including a polymer inclusive frame profile supported by a glass substrate, the method comprising:
providing a glass substrate;
mixing a first component comprising polyol and a second component comprising isocyanate together to form a foam mixture;
extruding the foam mixture onto at least a peripheral portion of a major surface of the glass substrate, wherein the foam mixture has a first height dimension (H1) immediately after being extruded;
the extruded foam mixture on the glass substrate emitting gas and enlarging so as to form a polymer inclusive foam frame profile on the glass substrate having a second height dimension (H2), where H2>H1.

40. The method of claim 39, wherein the foam frame profile is provided along at least one side of the glass substrate, and wherein the foam frame profile has a density of less than about 0.50.
